(19) United States
(12) Patent Application Publication
(10) Pub. No.: US 2008/0179228 A1
(43) Pub. Date: Jul. 31, 2008

(54) WASTEWATER EVAPORATOR WITH WASTE OIL BURNER

(76) Inventor: Raymond E. VanKouwenberg, Penfield, NY (US)

Correspondence Address: HISCOCK & BARCLAY, LLP, 2000 HSBC PLAZA, 100 Chestnut Street, ROCHESTER, NY, 14604-2404, US

(21) Appl. No.: 12/022,888

(22) Filed: Jan. 30, 2008

Related U.S. Application Data
(63) Continuation of application No. 60/887,222, filed on Jan. 30, 2007.

(51) Int. Cl. B01D 1/02

(52) U.S. Cl. 210/149; 210/175

(57) ABSTRACT

A compact, self-contained apparatus for treating wastewater containing as impurities and pollutants various non-volatile (at water boiling points) fluids such as greases, oils and soaps. The apparatus includes a vessel for collecting the wastewater and a heating chamber including waste oil burners and a heat transfer liquid such as mineral oil to heat the wastewater mixture to boil off the water and to reduce the volume of liquid for disposal. A wastewater supply tank may be positioned under the apparatus.

### CROSS-REFERENCE TO RELATED APPLICATIONS

This application claims priority from U.S. Provisional Patent Application Ser. No. 60/887,222, filed Jan. 30, 2007, which is herein incorporated by reference.

### FIELD OF THE INVENTION

This invention relates to apparatus for the treatment of wastewater resulting from cleaning of, for example, buildings, vehicles and machinery by reducing the volume of wastewater required for disposal by an efficient water evaporation utilizing a waste oil burner as a heat source.

### BACKGROUND OF THE INVENTION

As explained in my U.S. Pat. No. 6,887,344, No. 5,582,680, and No. 6,200,428, the entire disclosures of which are incorporated by reference into this application, good manufacturing processes, concern for the environment, and changes in environmental practices and regulations all have created additional needs in handling waste fluids after manufacturing and cleaning operations, especially in disposing of water based mixtures containing pollutants such as greases, oils, soaps, heavy metals, road film and carcinogens. Whereas in the past it was acceptable merely to dump such waste liquids in the ground or in sewer systems, current good practices and environmental laws and regulations now severely discourage and/or prohibit such practices. Although very laudable in intent, the result can be very costly, especially to businesses who must use substantial quantities of water in their operations, as for example to clean buildings, vehicles and other machines, which will result in wastewater containing greases, oils, minute metallic and other particles, and detergents. Additionally, there are many wastewater sources for which mass reduction by evaporation is useful.

Each of the aforementioned patents describes and claims an apparatus operated on the evaporation principle and which is relatively inexpensive to manufacture, simple and safe to operate, and relatively more efficient in the active removal of non-volatile fluids and contaminants from wastewater. What is needed is an improvement to such apparatus that is compact and useful in the myriad operations that produce wastewater, such as in the treatment and reduction of wash and rinse water resulting from the cleaning and or mopping of buildings, vehicles and machinery, including especially the large amounts of wastewater generated by cleaning large areas of high trafficked floors in commercial and industrial facilities using power scrubbing equipment.

The waste left after water has been removed from a waste stream may comprise a dry powder of solids in certain cases or, potentially, a waste oil. Such a waste oil may come from petroleum products in the wastewater or many businesses may have waste oil from other sources. While this oil is considered a waste, the oil may still be used as an energy source, such as by burning the waste oil as a fuel source in a heating apparatus. It would be a benefit to a business to use this waste as a fuel source; however, waste oil tends to leave a significant residue when combusting with numerous contaminants. Cleaning the equipment that burns waste oil is needed to extend the life of the equipment.

Thus, an apparatus that is compact and easily moved within a facility, and uses an environmentally safe heat transfer fluid and an optional disposable liner to contain the wastes remaining after evaporation is needed. Further, a waste oil heating system that provides heat to a wastewater evaporator to utilize an energy source that may otherwise be wasted is needed.

### SUMMARY OF THE INVENTION

In accordance with this invention, there is provided a novel wastewater treatment apparatus that treats wastewater containing, as impurities and pollutants, various non-volatile (at water boiling points) fluids such as greases, oils, carcinogens and detergents, by vaporizing the water using a waste oil heating system and a heat transferring mineral oil by which heat transfer is effected.

An advantage of the present invention is that the apparatus offers significant savings in labor, reduction of contamination risk, and energy savings. Further, the invention provides an easily cleaned waste oil heating system that allows an increased use of resources as the waste oil may come from the wastewater stream treated by the apparatus or other sources.

### BRIEF DESCRIPTION OF THE DRAWINGS

The present invention is disclosed with reference to the accompanying drawings, wherein:

FIG. 1 is a partial isometric view of a first embodiment of this invention, taken on line 1-1 of FIG. 2 and showing the essential structure of a wastewater treatment apparatus according to the invention;

FIG. 2 is a side view of the first embodiment of the apparatus as shown in FIG. 1, with the wastewater tray shown in partial cross section;

FIG. 3 is a cross-sectional view taken on line 3-3 of FIG. 2;

FIG. 4 is a top view of the embodiment of FIGS. 1 and 2 with the waste oil burners shown in phantom;

FIG. 5 is a partial sectional view of one end of a heat tube of FIG. 1;

FIG. 6 illustrates the liner of the present invention;

FIG. 7 is a partial isometric view of the preferred embodiment of this invention, taken on line 7-7 of FIG. 8 and showing the essential structure of a wastewater treatment apparatus according to the invention;

FIG. 8 is a side view of the preferred embodiment of the apparatus as shown in FIG. 7;

FIG. 9 is a cross-sectional view taken on line 9-9 of FIG. 8;

FIG. 10 is a top view of the embodiment of FIGS. 7 and 8;

FIG. 11 is a sectional view of the reentrant tubes of FIG. 7 with one turbulator in place one turbulator partially inserted; and

FIG. 12 is an end view of the heat tube and reentrant tubes of FIG. 7.

Corresponding reference characters indicate corresponding parts throughout the several views. The examples set out herein illustrate several embodiments of the invention but should not be construed as limiting the scope of the invention in any manner.

### DETAILED DESCRIPTION

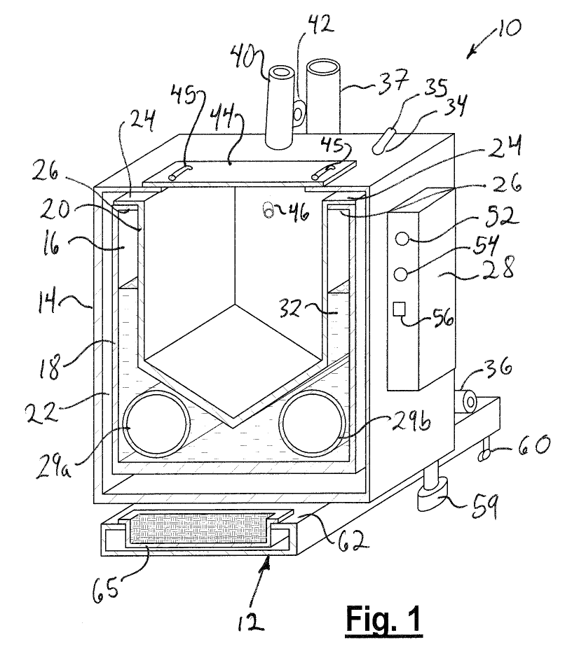

Referring to FIG. 1, an embodiment of the present invention comprises a wastewater treatment apparatus 10 and an optional separate wastewater receiving tank 12. Apparatus 10 includes an external jacket 14 substantially cubic in shape, though other shapes may be used. Contained inside and spaced from jacket 14 is an interior heat generating chamber 16 which is defined at its outside by a heating vessel 18 (e.g., 10 gauge steel) having side walls and a bottom wall as shown, and on the inside by a fluid (e.g., wastewater) receiving vessel 20 with a V-shaped bottom wall and preferably being titanium or stainless steel (e.g., having an internal volume of about 60 gallons, 160 gallons, or 200 gallons and being 151/gauge). Heating vessel 18 in turn is spaced from outer jacket 14 by an air space 22 (e.g., about 2 inches in width on all four sides). Although not shown, heating vessel 18 may be supported at its bottom by jacket 14 using vertical posts or the like.

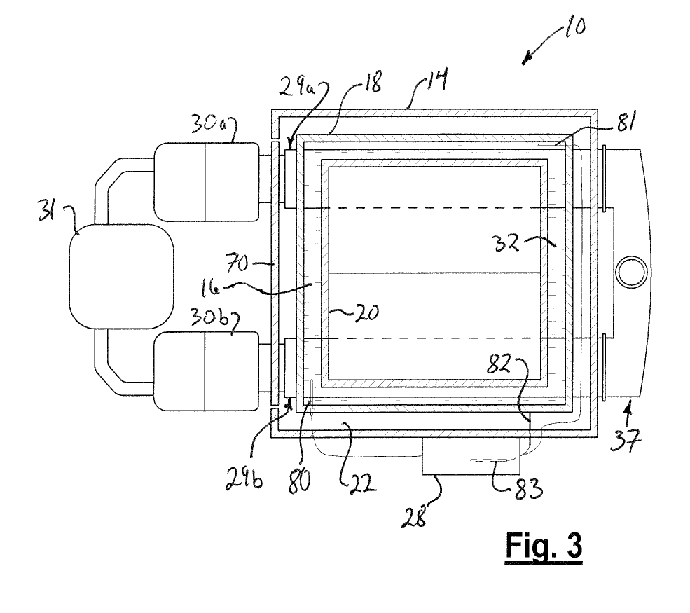

Fluid receiving vessel 20 as shown includes side walls, a V-shaped bottom wall and at least a partially open top. Similarly to my previous U.S. Pat. No. 6,887,344, fluid vessel 20 in turn is supported by heating vessel 18 by outwardly extending (e.g., 4 inch) flanges 24 at the top of all four sides sitting atop similar, inwardly extending flanges 26 at the top of all four sides of heating vessel 18. As thus shown in FIGS. 1 and 3, heating chamber 16 extends across the bottom wall and the height of the side walls of fluid vessel 20. Vessels 18 and 20 may be welded together by their respective flanges, but preferably are held together by detachable means such as stainless steel bolts to enable vessel 20 to be readily removed for maintenance of heating chamber 16 and the heating elements to be described.

Within heating chamber 16 and below vessel 20 as shown in FIGS. 1, 3, and 5 are two heat tubes 29a and 29b (e.g., 10 inches in diameter) each in respective communication with a waste oil burner 30a and 30b that blows ignited waste oil through the heat tube. Turbulators 33 installed at the ends of heat tubes 29a, 29b are vanes having a shape and an orientation appropriate to provide an even distribution of the heat within the heat tubes 29a, 29b. The heat tubes output the exhaust into the flue pipe 37, which is separate from the steam exhaust pipe 40 described below to keep the typically dirty waste oil exhaust separate from the evaporated water. A waste oil reservoir 31, which may include a filtered input, supplies waste oil to the waste oil burners 30a and 30b via hoses or pipes. In a particular embodiment, the waste oil may be mixed with a fuel oil. The waste oil heaters 30a,b are preferably equipped with high performance air filters in order to supply clean air with the waste oil for improved combustion.

The heat tubes 29a,b are preferably straight tubes because burning waste oil will tend to leave a significant amount of residue in the tubes. Straight tubes can be easily cleaned on a regular basis. To facilitate this, waste oil burners 30a,b are at least partly supported by a door 70 in the external jacket 14 that may be removed or swung open to expose the open ends of the heat tubes 29a,b so that they may be cleaned. Further, since waste oil may have various contaminants that may be unknown depending on the source of the waste oil, it may be necessary to filter or scrub the exhaust. In this regard, removable filters or a scrubber system may be placed in communication with the flue pipe 37 or the output of the heat tubes 29a,b.

In addition, heating chamber 16 is substantially filled (e.g., about one half the depth of chamber 16) with a non-toxic, heat transfer liquid mineral oil 32 such as PARATHERM NF Heat Transfer Fluid supplied by Paratherm Corporation of Conshocken, Pa., to evenly distribute to vessel 20 the heat transferred from the heat tubes 29a,b and causing the wastewater contained in the fluid vessel to boil and evaporate while enabling the contaminates in the wastewater to settle in vessel 20 in concentrated form for later disposal. Also, as shown in FIGS. 1 and 3, heat transfer oil 32 fills at least the entire bottom and a substantial portion of the sides of heating chamber 16. Such a mineral oil can be heated up to 600° F., which on being so heated begins to circulate convectively to carry the heat to the fluid receiving vessel. In order to ensure efficient heat transfer from the heat tubes 29a,b to the heat transfer oil 32, the waste oil heaters 30a,b run at no more than a combined 500,000 BTU. In a particular embodiment, the waste oil heaters 30a,b run at 230,000 BTU each.

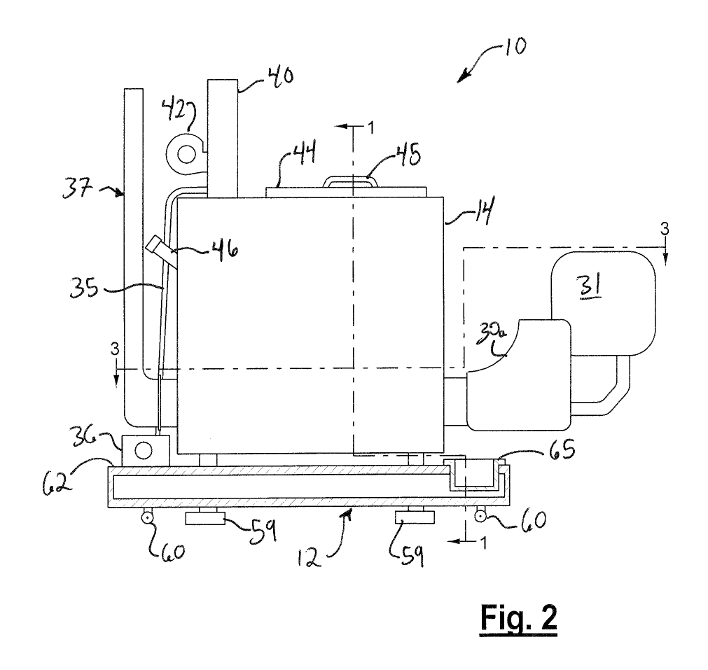

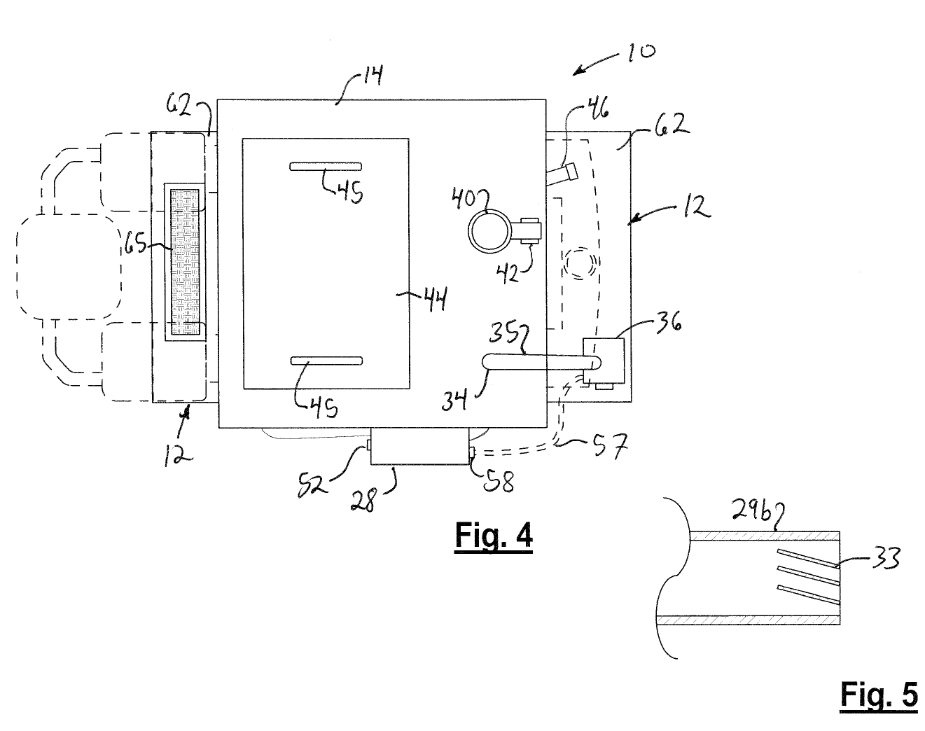

As described in my previous U.S. Pat. No. 6,887,344, the wastewater is delivered to vessel 20 by an inlet 34 connected by a pipeline or flexible hose 35 and self priming pump means 36 to a suitable supply tank, such as tank 12, as shown in FIGS. 2 and 4. Of course, alternative wastewater delivery systems may be used including batch and continuous delivery systems as well as automatic and manual delivery systems. Water vapor, as it is generated, escapes from vessel 20 in the apparatus from space 22 by exhaust pipe 40 that preferably includes an exhaust blower fan 42 to facilitate the air flow and exhaust. In a preferred embodiment, the blower 42 is a draft induction blower. There also is provided on the top of the jacket 14 a removable access cover 44 that may be lifted off by handles 45 as shown to expose the inside of vessel 20 through at least a partially open top for inspection and routine maintenance, and may also be available for hand filling of wastewater from pails and the like.

At the rear of vessel 20 is an access pipe 46 extending through both jacket 14 and vessel 18 and opening into vessel 20 to enable the insertion of a hose to pump out any contaminate-concentrated water remaining in the apparatus for suitable disposal. Pipe 46 (FIGS. 1, 2, and 4), which may include a removable cap on its outer side, is preferably angled, for example at 45 degrees, to enable the inserted hose to be extended to the bottom of vessel 20. Alternatively, the pipe 46 may be a drain located at the bottom of the “V” formed by the bottom wall of the vessel 20. Further, the bottom of the “V” may be sloped with the pipe 46 being located at the nadir of the vessel 20.

Similarly to my previous U.S. Pat. No. 6,887,344, power to operate apparatus 10 is supplied to the control panel 28 mounted at the side of jacket 14 as shown, with the electrical power delivered through a suitable 3-prong plug from any 110 volt receptacle. The control features may include those described in my patent, U.S. Pat. No. 5,582,680, but may also simply comprise a “dead man” switch 52 to power supply pump 36 only while switch 52 is actively held in its closed position by the operator, an optional combined start-stop 24-hour timer control 54 to start and shut off the electrical power at selectable times, and a “HI-LO” switch 56 to select alternative high and low heat settings of, for example, 350° F. and 150° F., respectively.

Further as shown, apparatus 10 is supported by suitable legs 59, which preferably are adjustable in height and may include lockable casters for easy movement.

As described in my previous U.S. Pat. No. 6,887,344, the removable wastewater supply tank 12 (e.g., about 24 inches wide and 4 inches high) preferably extends beyond apparatus 10 (e.g., 10 inches at each end) to enable a direct fill from the drain of a power scrubber and is mounted on casters 60 to enable the tank 12 to be moved out from under apparatus 10. The top wall 62 of tank 12 includes an access opening through which wastewater is dumped into a removable filter tray 65 placed in tank 12, and supply pump 36 which is mounted on a bracket detachable from top wall 62 (to enable pump 36 to be used with other wastewater supply means) connected by the flexible, detachable hose 35 to inlet 34. The example size of tank 12 is sufficient to hold wastewater from a 50-gallon power scrubber. The power cord 57 (FIG. 4) for pump 36 may conveniently be plugged into a twist lock receptacle 58 in control panel 28 to operate the pump from the control panel. Filter tray 65 is removable and may include a disposable filter bag into which the waste water is poured to filter out larger particles in the wastewater. Filter tray 65 may be made of any suitable close mesh material such as a polyester that, when full, can be removed and incinerated or otherwise properly disposed along with its filtered contents.

Pump 36 may alternatively be mounted directly on the back wall of jacket 14. If desired, or if necessary because of local environmental regulations, the evaporating discharge pipe 40 can be connected to a conventional water condenser coil (not shown) to collect distilled water for reclaiming and reuse as washwater.

In operation, the apparatus is first filled with wastewater generated by a floor scrubber or the like, either by hand or through supply tank 12 by holding pump switch 52 closed until vessel 20 is filled to an appropriate level. The preferred heating level is then set on HI-LO switch 56 and the timer control 54 is then set both to close the heating circuit for the selected time and to actuate blower fan 42 causing the wastewater to reach its boiling temperature, evaporate the water and expel the water vapor from the apparatus. When the water is substantially evaporated, the remaining waste is then removed from vessel 20 through pipe 46 or cover 44.

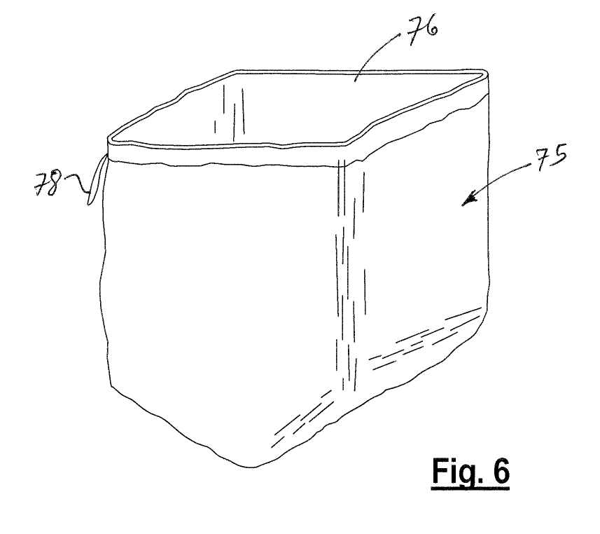

Referring now to FIG. 6 and as described in my previous U.S. Pat. No. 6,887,344, an alternate embodiment of the present invention comprises a disposable liner 75, made of a material that is waterproof and both nonporous and impervious with respect to the expected content of contaminants in the wastewater, and which is further capable of withstanding heat up to about 450° F., for example a 32 oz. silicone rubber coated, fiberglass woven fabric identified as G32SIL and manufactured by Amatex Corporation of Norristown, Pa.

Liner 75 is fabricated so as to prevent the through-passage of water and waste, the sides and bottom of liner 75 conforming in its outer shape to the contours of the fluid receiving vessel 20 of the wastewater treating apparatus. Liner 75 has at least one closeable opening 76 at its top to admit unprocessed wastewater from any source and vent evaporating water during operation to reduce the nonvolatile contaminates to their dry state. Liner 75 is formed of sufficient material at its top to be capable of being sealed shut and removed from fluid receiving vessel 10 and disposed, for example by incineration, along with the residue. The closure may consist of draw string 78 as shown or other suitable means such as adhesive tape.

If the temperature difference between the heat tubes and the oil exceeds certain limits, the efficiency of the heat transfer from heat tubes to oil is reduced, due in part to radiative and conductive cooling through the external walls of the heating chamber containing the oil and the heat tubes, and due in part to variations in convective behavior of the oil at different temperature ranges and viscosities. Consequently, a means is described whereby the relative differences between the oil temperature, the heating vessel temperature, and the ambient temperature may be held within such limits as will promote a maximally efficient transfer of heat to the oil and energy savings. This means is similar to the means described in my previous U.S. Pat. No. 6,887,344 and contributes to the useful life of the heat tubes and the heat transfer fluid.

To accomplish the foregoing, an alternate embodiment of the invention includes the incorporation of several thermally-activated sensors, two immersed in the oil in the heating vessel and not touching other surfaces or substances, another attached directly to the surface of the heating vessel, and the fourth located in the control box. The sensors are interconnected in the electrical circuit so that when the temperature differences between the sensors exceed a certain preset limit, the waste oil burners are turned off.

To control the heating circuit as described and as shown in FIG. 3, thermally-activated sensors or thermocouples 80, 81, 82 and 83, for example sensor type Rapidship MI manufactured by Watlow-Gordon of Richmond, Ill., are connected to the waste oil burner activation circuit. The thermal sensor elements of sensors 80 and 81 are suspended in oil 32 in heating vessel 18, the thermal sensor element of sensor 82 is mounted against the surface of the heating vessel 18, and the thermal sensor element of sensor 83 is located within the control box 28.

Thermally-activated sensors 80, 81, 82 and 83 are connected to a heating control circuit of any type that detects differences in temperature between two or more sensors and changes the state of a power-circuit switching means depending on the relationship between those differences and a set value, e.g.:

| Condition | Action |
|---|---|
| Differences between respective | Close switching means to waste oil |
| sensors less than set value | burners 30a, b |
| Differences between any two | Open switching means to open circuit |
| sensors exceeds respective set | to waste oil burners 30a, b |
| value | |

A suitable preset value may be about 30° F. such that the switching means is closed if the temperature differences are less than that amount and open if more than that amount. The waste oil burners 30a,b are actuated and deactuated through a circuit switching means as described above. When the starter button of apparatus 10 is first closed, the switching means is closed to activate the waste oil burners 30a,b to blow ignited waste oil through the heat tubes 29a,b, respectively, and raise the temperature of the heat transfer fluid 32 sufficiently to cause wastewater in vessel 20 to be evaporated. However, as the transfer fluid 32 is being heated, the temperature of the heat tubes 30a,b will continue to rise even faster and cause temperature gradients to occur within the transfer fluid 32.

The temperature probes 80, 81, 82, 83 are provided to limit the temperature differential. Consequently, when a difference in temperature between two of the thermally-activated sensors exceeds a set value, the heating circuit will deactivate the waste oil burners 30a,b until the temperature of the heat tubes 29a,b drops to a level at which the temperature differential is less than the set value. At that time, the differences in temperature between thermally-activated sensors does not exceed the set value and the waste oil burners 30a,b continue heating the heat transfer fluid 32. In a particular embodiment, the waste oil burners are actuated and deactuated individually so that the control circuit may run the waste oil burners individually to reduce a horizontal temperature differential if needed. This more energy efficient cycle continues until the heat transfer fluid 32 reaches and is maintained at its preset operating temperature to cause evaporation of the wastewater. The operation may continue by adding more wastewater as desired. When a sufficient amount of contaminants has been collected, the apparatus 10 preferably is operated until all of the remaining wastewater is evaporated leaving a residue that is free of water in the contaminants in liner 75 for disposal by an environmentally safe means.

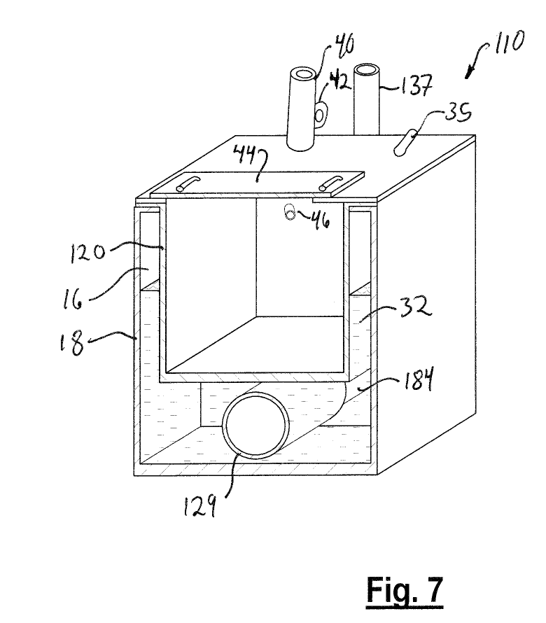

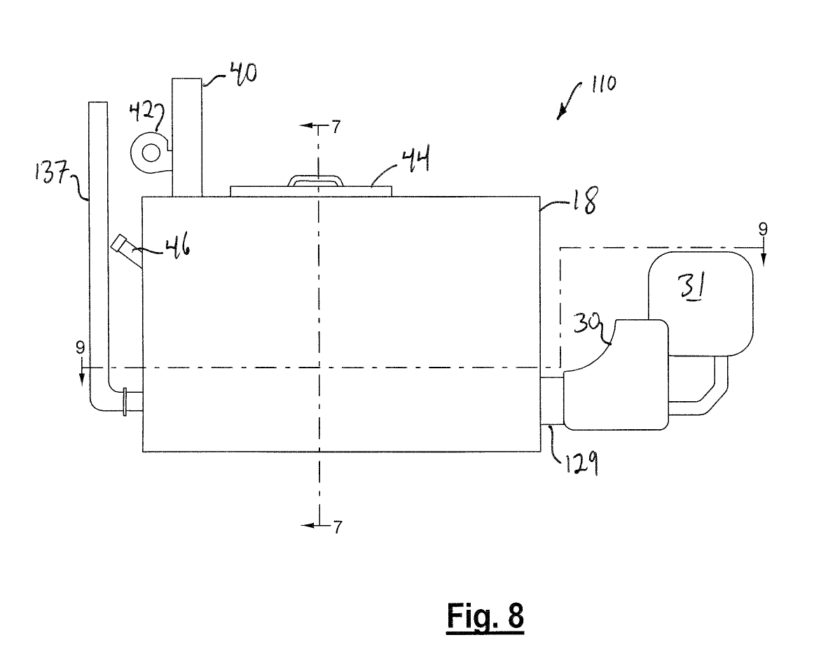

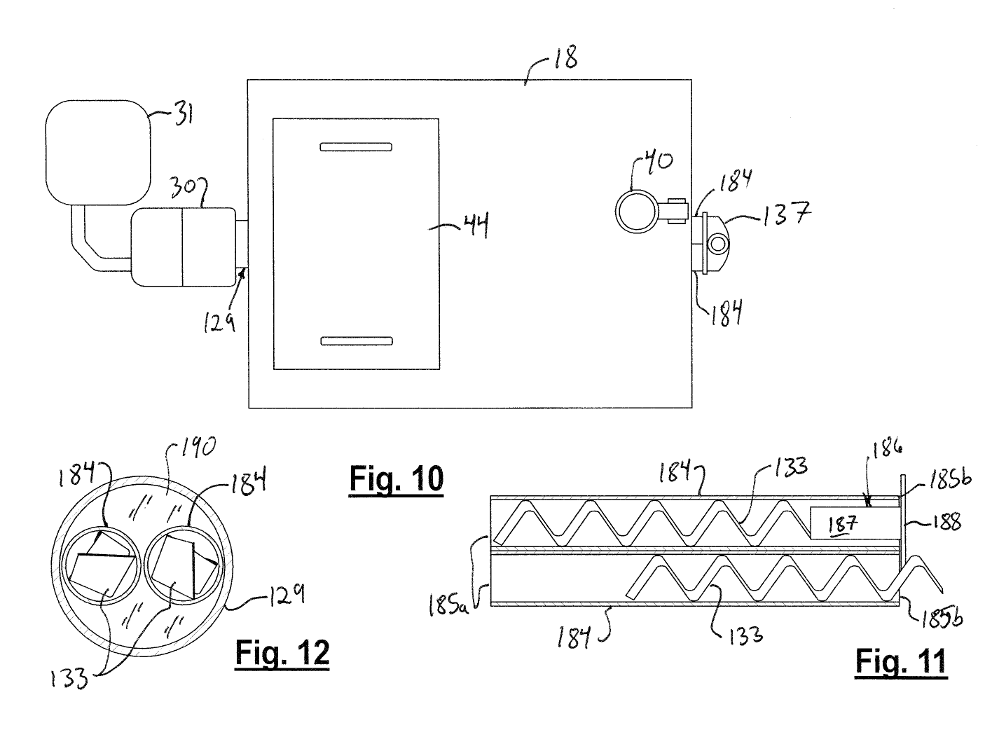

In a more preferred embodiment shown in FIGS. 7-12, the wastewater treatment apparatus 110 includes a fluid receiving vessel 120 having a substantially flat bottom, and one or more heat tubes 129 with reentrant tubes 184. The same reference numbers are used for elements that correspond to the elements described in the previous embodiments.

The vessel 120 simplifies the construction and maintenance of the apparatus 110 because one may use a standard vessel that may be used with other wastewater treatment apparatus. While not shown in the figures, a jacket or similar structure as described in the previous embodiments may be used in the preferred embodiment. The vessel 120 is contained within the heating vessel 18 forming the heating chamber 16. The heat transfer fluid 32 is contained in the heating chamber 16 in contact with the outer surface of the heat tube 129 and the reentrant tubes 184.

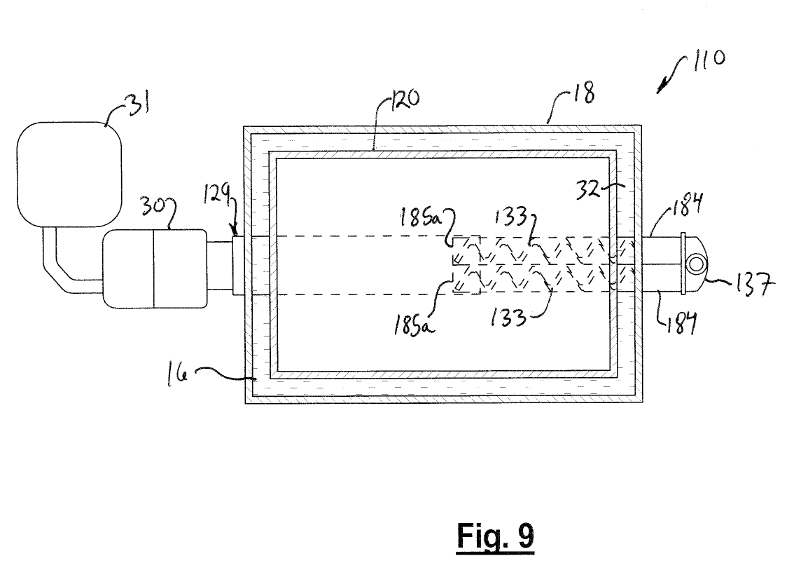

The heat tube 129 and reentrant tubes 184 are best shown in FIGS. 9 and 11. While only a single heat unit (burner, heat tube, and two reentrant tubes) is shown in the figures, two or more units may be used. In a particular embodiment, the heat tube 129 is a 10-in diameter tube, the reentrant tubes 184 are 4-in diameter tubes, and the reentrant tubes 184 extend about 4-in into the heat tube 129. The tubes comprise a heat-conducting metal. The heat tube 129 and reentrant tubes 184 are straight for easy cleaning of the residue left by the combusting waste oil. The heat tube 129 is in communication with the waste oil burner 30 and the reentrant tubes 184 exhaust into a flue pipe 137. The heat tube 129 includes an end wall 190 (FIG. 12) that closes the end of the heat tube 129 around the reentrant tubes 184 to prevent the combusting gasses from escaping into the heating chamber 16.

The preferred turbulators 133 are best shown in FIGS. 11 and 12. A turbulator 133 according to the preferred embodiment is a plate of metal that slides into the reentrant tube and is shaped to provide a tortuous path for the combusting waste oil in the reentrant tube. This improves the heat transfer of the hot gasses to the fluid 32. Further, the inlets 185a of the reentrant tubes 184 are located some distance (e.g., 4-in) within the heat tube 129. This slows the exit of the hot gasses from the heat tube 129 into the reentrant tubes 184.

The preferred placement of the turbulators 133 within the reentrant tubes 184 is so that the turbulator extends from the inlet 185a of the reentrant tube to the edge of the heating chamber 16 as shown in FIG. 9. The placement may be made using a tool 186 shown in FIG. 11. The tool 186 includes an insertion plate 187 and a stop plate 188. The insertion plate is the length from the outlet 185b of the reentrant tube 184 to the edge of the heating vessel 18. The insertion plate 187 pushes the turbulator 133 into the reentrant tube 184 until the stop plate 188 contacts the outlet 185b. The tool 186 is removed from the reentrant tube 184 and the turbulator 133 is left in the preferred position. Alternatively stops may be welded or otherwise fastened into the reentrant tubes 184 to aid in placing and retaining the turbulators 133.

The features and operation of the previous embodiments may be incorporated into the preferred embodiment as desired. For example, a liner similar to the liner 75 may be used in conjunction with the fluid vessel 120. In a further example, the supply tank 12 may be used with the preferred embodiment. In an even further example, a heating control circuit and thermocouples are used in the preferred embodiment.

From the description above, it should be clear that the present invention offers significant savings in labor, reduction of contamination risk, and energy savings. The use of waste oil as the fuel source in the heating portion of the apparatus allows an increased use of resources as the waste oil may come from the wastewater stream treated by the apparatus or other sources. This waste oil might normally be thrown away or incinerated; however, the configuration of the apparatus described above allows additional energy to be put to use from this waste. The use of a removable liner which may either be cleaned or disposed of substantially reduces the cleaning effort required for the apparatus. The use of the described temperature-difference control for the heating vessel reduces the waste of energy used in heating, and further adds to the useful life of the heat transfer fluid 32. It also may provide a degree of safety in case of heating vessel leakage or other abnormal condition.

It is to be understood that the aforementioned description is illustrative only and that changes can be made in the apparatus, in its components and their functions, without departing from the scope of the invention as defined in the following claims.

1. A wastewater treatment apparatus comprising:
a wastewater vessel for containing a volume of wastewater;
a heating vessel surrounding at least a portion of the wastewater vessel, the heating vessel containing a volume of a heat transfer liquid between the heating vessel and the wastewater vessel;
a heating tube mounted within the heating vessel and immersed in the heat transfer liquid; and
a waste oil burner in communication with one end of the heating tube and configured to direct ignited waste oil through the heating tube.

2. The wastewater treatment apparatus of claim 1, the heating tube being below the wastewater vessel.

3. The wastewater treatment apparatus of claim 1, the heating vessel having an exhaust pipe and the heating tube being in communication with a flue pipe that is separate from the heating vessel exhaust pipe.

4. The wastewater treatment apparatus of claim 1, further comprising two reentrant tubes extending into another end of the heating tube, the heating tube and the reentrant tubes cooperating to provide a fluid passage from the waste oil burner through the length of the heating vessel.

5. The wastewater treatment apparatus of claim 4, further comprising a turbulator situated within each reentrant tube.

6. The wastewater treatment apparatus of claim 5, the turbulators each comprising a plate having several bends to form a tortuous path for fluids in the reentrant tube.

7. The wastewater treatment apparatus of claim 5, the turbulators each extending from the interior of the heating tube to an edge of the heating vessel within one of the reentrant tubes.

8. The wastewater treatment apparatus of claim 7, the turbulators being slidable within the reentrant tubes and being placed within the reentrant tubes with a custom tool.

9. The wastewater treatment apparatus of claim 1, the heating vessel and the wastewater vessel having a substantially planar bottom wall.

10. The wastewater treatment apparatus of claim 1, further comprising an outer jacket with an air space formed between the jacket and heating vessel and means for circulating heat from the heating tube within the air space.

11. The wastewater treatment apparatus of claim 10, further comprising an exhaust pipe in communication with the air space and the wastewater vessel; and the circulating means comprising a draft induction blower in communication with the exhaust pipe.

12. The wastewater treatment apparatus of claim 1, further comprising a wastewater receiving tank and a pump configured to pump wastewater through a hose to the wastewater vessel.

13. The wastewater treatment apparatus of claim 12, the wastewater receiving tank comprising a filtered inlet.

14. The wastewater treatment apparatus of claim 1, further comprising a heating control circuit in communication with an activation circuit associated with the waste oil burner and comprising one or more thermocouples.

15. The wastewater treatment apparatus of claim 14, one of the thermocouples being situated within the heat transfer liquid, and the heating control circuit controlling the waste oil burner according to the temperature sensed by the thermocouple in the heat transfer liquid.

16. The wastewater treatment apparatus of claim 14, one or more of the thermocouples being situated within the heat transfer liquid and one of the thermocouples being situated outside the heating vessel, and the heating control circuit controlling the waste oil burner according to the difference in the temperature sensed by the thermocouples.

17. The compact wastewater treatment apparatus of claim 1, comprising:
two heating tubes;
the wastewater vessel having vertical side walls and a V-shaped bottom wall with at least two slanted sections joined at a bottom-most line of the bottom wall; and
the heating tubes being lateral to the slanted sections with a portion of the heating tubes being on opposing sides of and above the bottom-most line.

18. The compact wastewater treatment apparatus of claim 17, further comprising an outer jacket with an air space formed between the jacket and heating vessel, and means for circulating heat from the heating tubes within the air space.
